(19) United States
(12) Patent Application Publication
(10) Pub. No.: US 2007/0207013 A1
(43) Pub. Date: Sep. 6, 2007

(54) Binding method

(76) Inventor: Chun Fu Fu, Fongyuan City (TW)

Correspondence Address: PRO-TECHTOR INTERNATIONAL SERVICES, 20775 NORADA CT., SARATOGA, CA, 95070, US

(21) Appl. No.: 11/367,868

(22) Filed: Mar. 2, 2006

(51) Int. Cl. B42C 9/00

(52) U.S. Cl. 412/8

(57) ABSTRACT

Provided area binder including a heat resistant, rectangular thin member (e.g., paper), a lengthwise first adhesive formed on an intermediate portion of the thin member, two lengthwise second adhesives formed on both sides of the thin member, and two lengthwise gaps each formed between the first adhesive and the second adhesive and a method of binding pages comprising folding the second adhesives toward the first adhesive about the gaps to form an elongate member having a central groove of U-section, placing a predetermined number of sheets of paper in the groove for initially positioning same by the first and the second adhesives, heating the folded binder and the placed sheets of paper to melt the first and the second adhesives for binding the sheets of paper, and cooling.

### BACKGROUND OF THE INVENTION

1. Field of Invention

The present invention relates to binders and particularly to a method of binding sheets of paper by means of an improved binder.

2. Related Art

Staplers are conventionally used for binding sheets of paper together. Also, a wide variety of binders are commercially available. However, prior binders are typically unreliable in use. Thus, a need remains for an improved binder and a method of binding sheets of paper by means of same in order to contribute significantly to the advancement of the art.

### SUMMARY OF THE INVENTION

It is therefore an object of the present invention to provide a binder including a heat resistant, rectangular thin member, a lengthwise first adhesive formed on an intermediate portion of the thin member, two lengthwise second adhesives formed on both sides of the thin member, and two lengthwise gaps each formed between the first adhesive and the second adhesive, a method of binding pages comprising folding the second adhesives toward the first adhesive about the gaps to form an elongate member having a central groove of U-section; placing a predetermined number of sheets of paper in the groove for initially positioning same by the first and the second adhesives; heating the folded binder and the placed sheets of paper to melt the first and the second adhesives for binding the sheets of paper; and cooling the bound sheets of paper.

In one aspect of the present invention, the thin member is formed of paper.

In another aspect of the present invention, the thin member is formed of artificial fiber.

The above and other objects, features and advantages of the present invention will become apparent from the following detailed description taken with the accompanying drawings.

### BRIEF DESCRIPTION OF THE DRAWINGS

FIG. 1 is a perspective view of a preferred embodiment of binder according to the invention in its extended state;

FIG. 2 is a perspective view of the binder in its folded state;

FIG. 3 is a side view of the binder in FIG. 2 with sheets of paper being initially positioned therein;

FIG. 4 is a side view schematically depicting the binder and sheets of paper in FIG. 3 being placed in a heater prior to heating for binding; and

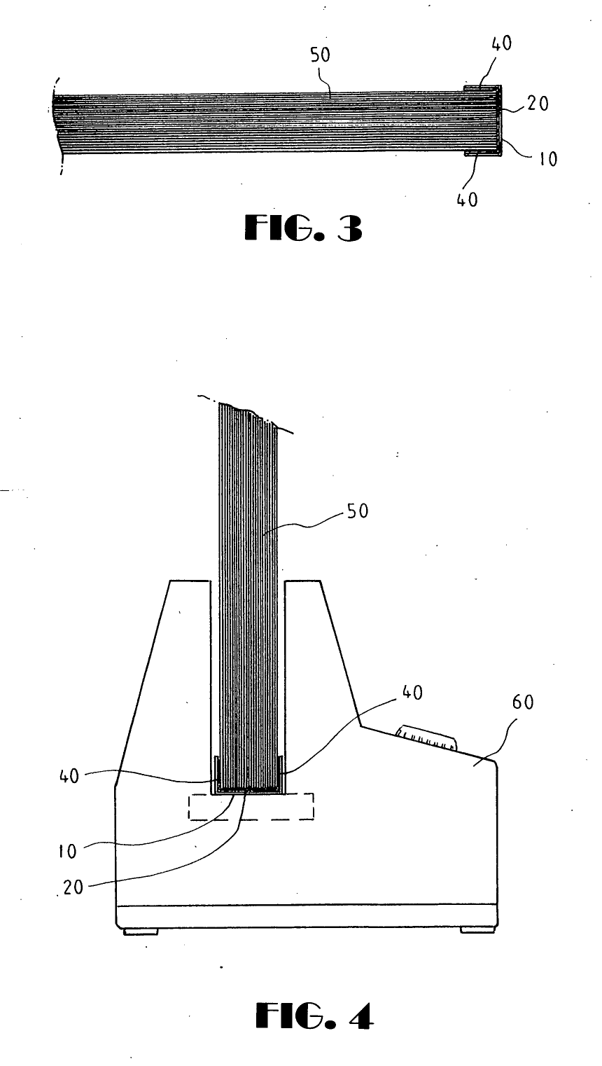

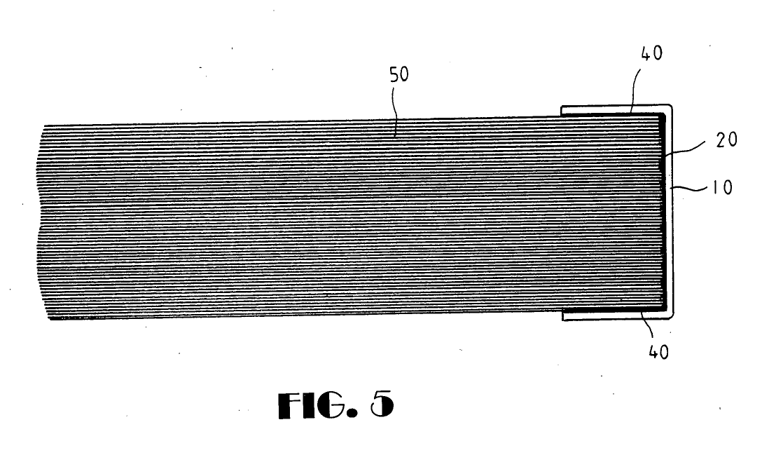

FIGS. Is a view similar to FIG. 3, where the sheets of paper have been bound.

### DETAILED DESCRIPTION OF THE INVENTION

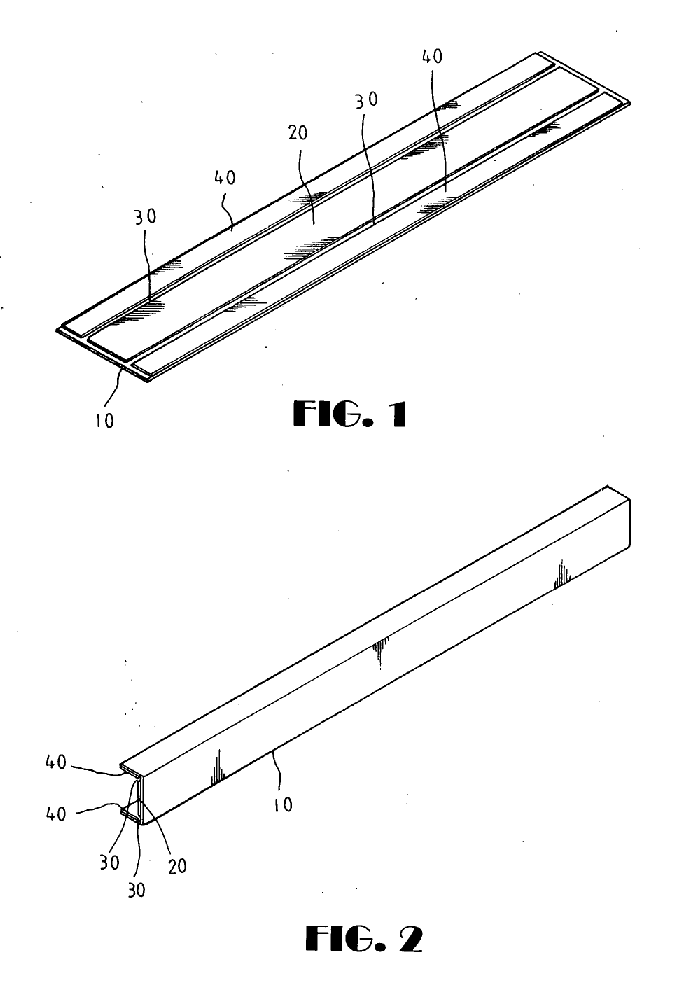

Referring to FIGS. 1, 2, and 3, a binder in accordance with a preferred embodiment of the invention, in its extended state, comprises a heat resistant, rectangular thin member (e.g., one made of paper or artificial fiber) 10, a lengthwise central adhesive 20 formed on an intermediate portion of the thin member 10, two lengthwise side adhesives 40 formed on both sides of the thin member 10, and two lengthwise gaps 30 each formed between the central adhesive 20 and the side adhesive 40. The side adhesives 40 are adapted to fold toward the central adhesive 20 about the gaps 30 to form an elongate member of U-section (see FIG. 2). A predetermined number of sheets of paper 50 are adapted to place in the U-shaped groove of the binder and are initially positioned by the central adhesive 20 and the side adhesives 40 (see FIG. 3).

Referring to FIGS. 4 and 5, a binding process by means of the binder of the invention will be described in detailed below. First, place the binder along with the placed sheets of paper 50 in a heating space of a heater 60. Next, activate the heater 60 to heat. The central adhesive 20 and the side adhesives 40 are melted to completely bind the sheets of paper 50. As a result, the purpose of binding sheets of paper is achieved after cooling. Note that for unbinding the sheets of paper 50 a person may activate the heater 60 to heat the bound sheets of paper 50 again for melting the central adhesive 20 and the side adhesives 40 prior to removing or replacing one or more sheets of paper 50. Thus, the binding is made easy by the invention. Also, the invention allows removal or replacement of sheets of paper after binding.

While the invention herein disclosed has been described by means of specific embodiments, numerous modifications and variations could be made thereto by those skilled in the art without departing from the scope and spirit of the invention set forth in the claims.

What is claimed is:

1. A binder including a heat resistant, rectangular thin member, a lengthwise first adhesive formed on an intermediate portion of the thin member, two lengthwise second adhesives formed on both sides of the thin member, and two lengthwise gaps each formed between the first adhesive and the second adhesive, a method of binding pages comprising the steps of:
folding the second adhesives toward the first adhesive about the gaps to form an elongate member having a central groove of U-section;
placing a predetermined number of sheets of paper in the groove for initially positioning same by the first and the second adhesives;
heating the folded binder and the placed sheets of paper to melt the first and the second adhesives for binding the sheets of paper; and
cooling the bound sheets of paper.

2. The method of claim 1, wherein the thin member is formed of paper.

3. The method of claim 1, wherein the thin member is formed of artificial fiber.
